(19) United States
(12) Patent Application Publication
(10) Pub. No.: US 2026/0031740 A1
(43) Pub. Date: Jan. 29, 2026

(54) RECONFIGURATION OF DIRECT CURRENT FAST CHARGING POWER ELECTRONIC MODULE TO PERFORM VEHICLE-TO-VEHICLE APPLICATIONS

(71) Applicant: Rivian IP Holdings, LLC, Irvine, CA (US)

(72) Inventors: Lixiang Wei, Irvine, CA (US); Chunhui Liu, Irvine, CA (US); Kyle Robert Underhill, Los Angeles, CA (US); Joo Min Yeo, Fullerton, CA (US)

(21) Appl. No.: 18/782,718

(22) Filed: Jul. 24, 2024

(51) Int. Cl. H02M 7/04; G06F 9/445; H02M 1/32; H02M 1/44; H02M 3/335

(52) U.S. Cl. CPC H02M 7/04; G06F 9/44521; H02M 1/32; H02M 1/44; H02M 3/33573; H02M 3/33576

(57) ABSTRACT

A power electronic modules (PEM) and method of manufacturing thereof are disclosed, the PEM including three input electrical terminals and two output electrical terminals. The method of manufacturing includes identifying a use of a PEM for either an alternating current (AC) to direct current (DC) operation and a DC/DC operation, selecting, using control circuitry of the PEM, one of at least two instances of firmware based on the use, and loading, by control circuitry, the selected instance of firmware to the PEM. When the use is AC/DC operation, the PEM is configured via the selected firmware to convert AC power received using the three input electrical terminals to DC power. When the use is DC/DC operation, the PEM is configured via the selected firmware to convert DC power received using two of the three input electrical terminals to DC power.

### INTRODUCTION

The present disclosure relates to power electronic modules (PEMs) that receive power from a power source and provide DC power to a device. More particularly, the present disclosure relates to PEMs configured with a firmware selected based on a use of the PEM.

### SUMMARY

The present disclosure is directed to power electronics modules (PEMs), and more particularly to PEMs that can be configured via software for either alternating current (AC) to direct current (DC) operation or DC-to-DC (DC/DC) operation. Such PEMs can be used in a charging system and receive power from a first device (e.g., DC power from a vehicle or AC power from a utility grid) and provide the received power to a second device (e.g., DC power to a charging vehicle).

In some embodiments, the present disclosure is directed to a PEM which identifies an intended use, and selects one of at least two instances of firmware based on the intended use, and loads the selected instance of firmware onto the PEM. In some embodiments, the PEM may be used for DC/DC operations (e.g., vehicle-to-vehicle charging) or AC-to-DC (AC/DC) operations (e.g., grid-to-vehicle charging).

In accordance with some embodiments of the present disclosure, a PEM and methods for manufacturing thereof are provided. In some implementations, the PEM includes control circuitry and power conversion circuitry having a power factor correction (PFC) circuit and a power converter (e.g., a dual-active bridge converter). The PEM is configured to receive power from a source and provide output DC power to a device (e.g., a vehicle). In some embodiments, the source is a second device (e.g., a second vehicle) which transmits DC power to the PEM. In other embodiments, the source is a utility grid or other suitable source for AC power, to transmit AC power to the PEM. In addition, the PEM comprises three input electrical terminals including first, second and third input electrical terminals, and two output electrical terminals The control circuitry is configured to select one of the at least two instances of firmware based on the use of the PEM, and load the selected instance of firmware to the PEM.

In some embodiments, the PEM is to be used for DC/DC operations (e.g., vehicle-to-vehicle charging), and the first input electrical terminal and the second input electrical terminal are electrically coupled to the DC power source (e.g., a first vehicle), from which the PEM receives DC power, and the first and second output electrical terminals are electrically coupled to a device (e.g., a second vehicle), to which the PEM transmits the output DC power. In such embodiments, the PEM is configured with a firmware for DC/DC operations and, for example, the third input electrical terminal is unused. When the use is a DC/DC operation, the control circuitry, using the selected instance of firmware, configures the PFC circuit to receive DC power from the source (e.g., a first vehicle) and transmit the DC power to the power converter. In addition, the control circuitry, using the selected instance of firmware, configures the power converter to receive the DC power from the PFC circuit and convert the DC power to an output DC power which is provided to a device (e.g., a second vehicle).

In some embodiments, the charging system is to be used for AC/DC operations (e.g., grid-to-vehicle charging), and therefore the first, second, and third input electrical terminals are each electrically coupled to an AC power source (e.g., a utility grid via a charger), from which the PEM receives AC power (e.g., three-phase power), and the first and second output electrical terminals are electrically coupled to a device (e.g., a vehicle), to which the PEM transmits the output DC power. In such embodiments the PEM is configured with a second firmware for AC/DC operations (e.g., utility grid-to-vehicle charging). When the use is an AC/DC operation, the control circuitry configures, using the selected instance of firmware, the PFC circuit to receive the AC power from the source (e.g., utility grid), correct the power factor of the received AC power and convert the AC power to DC power. The DC power is then transmitted to the power converter which is configured by the control circuitry using the selected instance of firmware. The power converter is configured to receive the DC power from the PFC circuit and convert the DC power to an output DC power.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1 shows an illustrative charging system from an electrical power grid to an electric vehicle (EV), the charging system implemented with a PEM, in accordance with an embodiment of the present disclosure;

FIG. 2 shows an illustrative charging system from a first EV to a second EV, the charging system implemented with another implementation of a PEM, in accordance with an embodiment of the present disclosure;

FIG. 3 shows an implementation of a PEM in accordance with an embodiment of the present disclosure;

FIG. 4 shows an illustrative diagram of the PEM shown in FIG. 3 in accordance with an embodiment of the present disclosure;

FIG. 5 shows an illustrative diagram of the PEM of FIG. 3 that is used for AC/DC operation, in accordance with an embodiment of the present disclosure;

FIG. 6 shows an additional illustrative diagram of the PEM of FIG. 3 that is used for DCDC operation, in accordance with an embodiment of the present disclosure;

FIG. 7 shows another illustrative diagram of a PEM including an electromagnetic interference (EMI) filter, precharge circuitry, and insulation monitoring device (IMD), in accordance with an embodiment of the present disclosure;

FIG. 8 shows as illustrative flowchart depicting a process for a power electronic module (PEM) to provide output direct current (DC) power to a device, in accordance with an embodiment of the present disclosure; and

FIG. 9 shows an illustrative flowchart depicting a process for manufacturing a PEM, in accordance with an embodiment of the present disclosure.

### DETAILED DESCRIPTION OF DRAWINGS

In some embodiments, the present disclosure is related to a PEM that may be configured to receive power from one of an AC power source (e.g., electrical power grid) and a DC power source (e.g., a first electric vehicle), convert the received power to output DC power and provide the output DC power to a DC power destination (e.g., a second electric vehicle). The PEM includes memory, power conversion circuitry to convert received power to DC power, and control circuitry, which may configure the power conversion circuitry depending on a use of the PEM. More specifically, the present disclosure is directed to methods for a PEM to provide DC power, PEMs, and methods for manufacturing PEMs that are configured, by control circuitry based on a use, wherein the use may be categorized as AC/DC operation (e.g., charging an electric vehicle from an electrical power grid) or DC/DC operation (e.g., vehicle to vehicle charging).

In some embodiments, the source (e.g., AC power source or DC power source) coupled to the PEM provides one of AC power or DC power to the PEM. When the PEM is configured by control circuitry for AC/DC operation, the PEM receives AC power from an AC power source and converts the AC power with power conversion circuitry in order to provide output DC power to a load (e.g., an electric vehicle). When the PEM is configured by control circuitry for DC/DC operation, the PEM receives DC power of a first voltage from an DC power source (e.g., a first electric vehicle) and converts the DC power with power conversion circuitry in order to provide output DC power of a second voltage to a load (e.g., a second electric vehicle). The control circuitry is communicatively coupled to the power conversion circuitry (e.g., AC/DC converter and the DC/DC converter) by respective signal buses to instruct the respective operation for the power conversion circuitry.

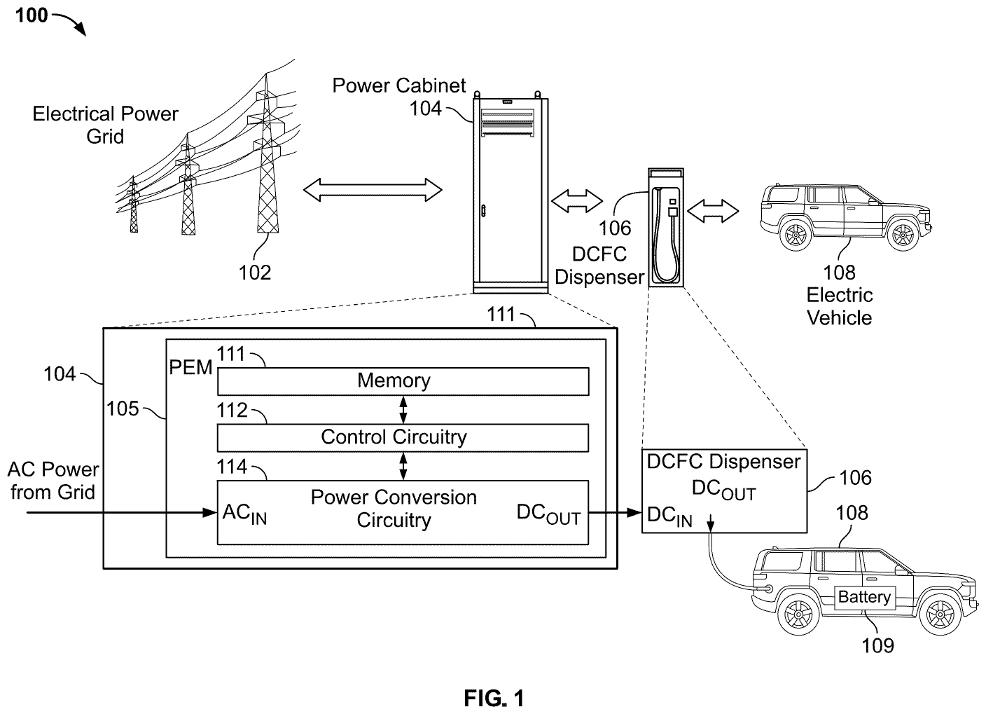

FIG. 1 shows an illustrative charging system 100 from an electrical power grid 102 to an electric vehicle (EV) 108, the charging system 100 implemented with a PEM 105, in accordance with an embodiment of the present disclosure. System 100 includes EV 108, direct current fast charger (DCFC) dispenser 106, power cabinet 104, and electrical power grid 102. Electric vehicle 108 includes rechargeable battery 109. Power cabinet 104 includes a power electronics module 105, which includes memory 111, control circuitry 112, and power conversion circuitry 114. Power cabinet 104 is coupled to electrical power grid 102 via one or more wired electrical power signal paths, by which electrical power grid 102 provides alternating current (AC) electrical power, such as in the form of a three phase 480 volt (V) 60 hertz (Hz) signal, to power cabinet 104. Power conversion circuitry 114 of the PEM converts the AC power received from the electrical power grid 102 into a DC power, such as a signal fixed at a voltage in a range from 200 to 920 V and a maximum current of 500 amps (A) at a maximum power of 300 kilowatts (KW). However, this is only one example, power conversion circuitry 114 may provide any suitable voltage and current range. In some implementations, the power conversion circuitry 114 includes any suitable AC-DC converter to convert AC power received from electrical power grid 102 to DC power. Although FIG. 1 shows that AC power is sourced from electrical power grid 102, the AC power received by PEM 105 may be from any suitable AC power source. Power conversion circuitry 114 may also include a DC/DC converter (e.g., a dual-active bridge convertor (DAB) converter), which converts the DC power into an output DC power, which is provided to DCFC dispenser 106 to charge battery 109 via a charging port of electric vehicle 108. As described in further detail below, control circuitry 112, which is electrically coupled to memory 111 and power conversion circuitry 114, is configured to select one of at least two instances of firmware based on a use of PEM 105 (i.e., AC/DC operations as shown in FIG. 1) and loading the selected instance of firmware to PEM 105, as described in further detail below.

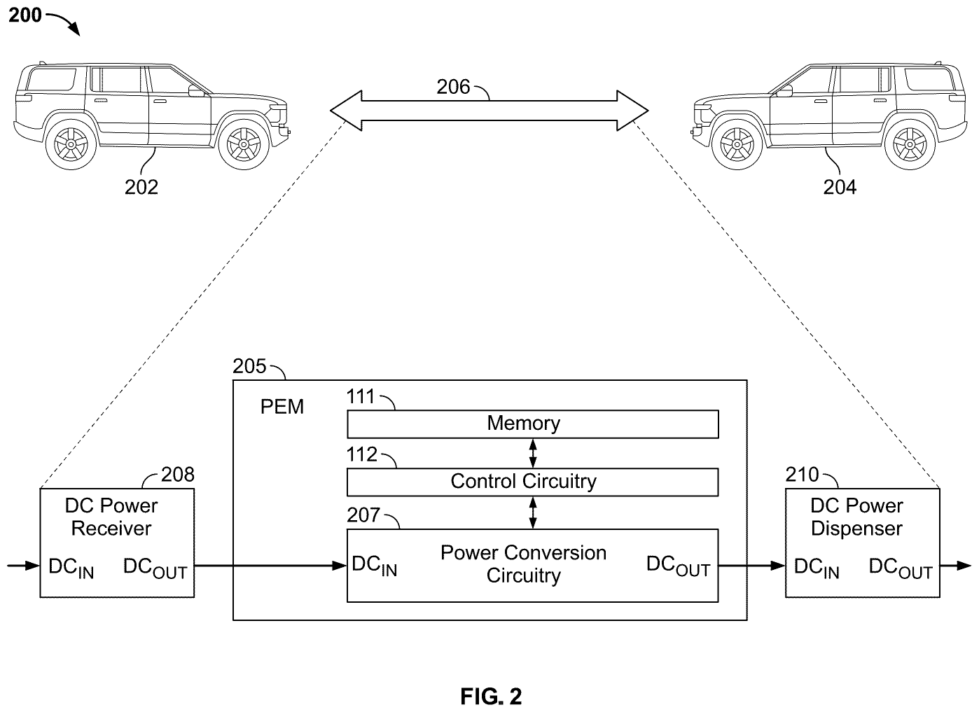

FIG. 2 shows an illustrative charging system 200 from a first electric vehicle 202 to a second electric vehicle 204, charging system 200 implemented with another implementation of a PEM 205, in accordance with an embodiment of the present disclosure. System 100 includes first electric vehicle 202, second electric vehicle 204, and vehicle-to-vehicle (V2V) charging system 206. V2V charging system 206 includes a DC power receiver 208, PEM 205, and DC power dispenser 210. In some embodiments, each of the first electric vehicle 202 and the second electric vehicle 204 includes a rechargeable battery. V2V charging system 206 includes PEM 205, which includes memory 111, control circuitry 112, and power conversion circuitry 207. V2V charging system 206 is coupled to the first electric vehicle 202 and the second electric vehicle 204 via one or more wired electrical power signal paths, by which first electric vehicle 202 provides DC electrical power to the V2V charging system 206. Power conversion circuitry 207 of the PEM 205 converts the DC power received from the first electric vehicle 202 into output DC power. Although FIG. 2 shows that DC power is sourced from first electric vehicle 202, the DC power received by PEM 205 may be from any suitable DC power source. Power conversion circuitry 207 may provide any suitable voltage and current range for output DC power provided to DC power dispenser 210. In some implementations, the power conversion circuitry 207 includes any suitable DC/DC converter (e.g., a DAB converter) to convert DC power received from first electric vehicle 202 to output DC power. In some embodiments, the output DC power is provided to DC power dispenser 210 to charge the rechargeable battery of the second electric vehicle 204 via a charging port of electric vehicle 204. As described in further detail below, control circuitry 112, which is electrically coupled to memory 111 and power conversion circuitry 207, is configured to select one of at least two instances of firmware based on a use of PEM 205 (e.g., DC/DC operations as shown in FIG. 2) and loading the selected instance of firmware to PEM 205, as described in further detail below.

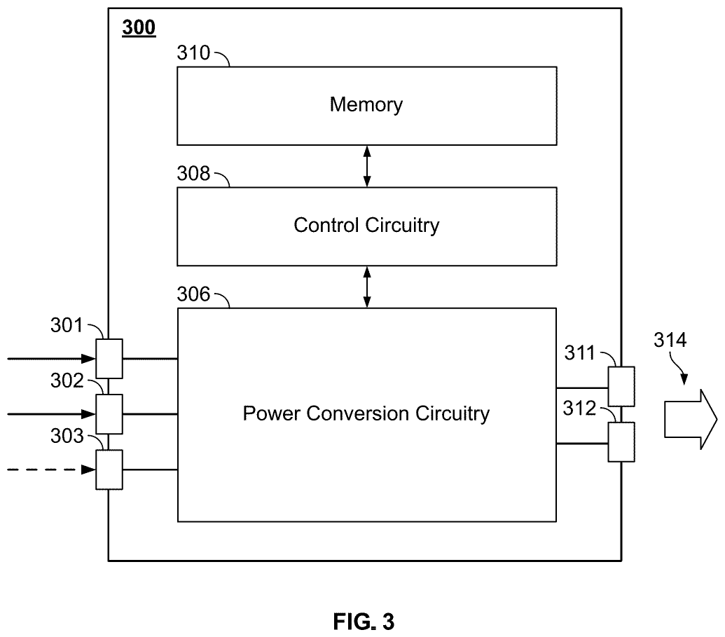

FIG. 3 shows a PEM 300 which provides output DC power 314 in accordance with an embodiment of the present disclosure. PEM 300 may be configured to be used as either PEM 105, as shown in FIG. 1, or PEM 205, as shown in FIG. 2. PEM 300 includes three input electrical terminals (e.g., first input electrical terminal 301, second input electrical terminal 302, and third input electrical terminal 303) and two output electrical terminals (e.g., first output electrical terminal 311 and second output electrical terminal 312). PEM 300 may be configured to: (1) receive AC power through each of the input electrical terminals (e.g., 301, 302, 303) and provide output DC power 314 through each of the output electrical terminals (e.g., 311 and 312) and (2) receive DC power through first input electrical terminal 301 and the second input electrical terminal 302 and provide output DC power 314 through each of the output electrical terminals (e.g., 311 and 312). Memory 310 may be an electronic storage device or any other suitable storage device. As referred to herein, the phrase “electronic storage device” or “storage device” should be understood to mean any device for storing electronic data, computer software, or firmware, such as random-access memory, read only memory, solid state devices, or any other suitable fixed or removable storage devices, and/or any combination of the same. Memory 310 may be used to store instances of firmware for various uses of the PEM, various types of instructions, rules, and/or other types of data. In some embodiments, control circuitry 308 executes instructions for an application stored in memory 310 (e.g., to implement power conversion circuitry 306). In some embodiments, control circuitry 308 and power conversion circuitry are configured by a selected instance of firmware from at least two instance of firmware stored in memory 310, where the selected instance of firmware is determined based on a use of the PEM. Specifically, control circuitry 308 may be instructed by the application to perform the functions discussed herein. In some implementations, any action performed by control circuitry 308 may be based on instructions for the instance of firmware. For example, an application may be implemented as software or a set of executable instructions that may be stored in memory 310 and executed by control circuitry 308.

Memory 310, in some aspects, stores at least one instance of firmware for AC/DC operations and at least one instance of firmware for DC/DC operations, along with the instructions and rules for each instance of firmware. Example types of rules include computational constants (e.g., values related to field effect transistors (FETs), inductors and/or transformers of power conversion circuitry 306), and/or other types of information or data. In some aspects, instructions are executed by control circuitry 308 to implement steps of various methods described herein.

Control circuitry 308 is configured to be in communication with memory 310 and power conversion circuitry 306. Control circuitry 308 is configured to transmit and receive instructions, settings, and rules of a selected instance of firmware based on the use of PEM 300 and/or other types of data to and from memory 310. Control circuitry 308 is also configured to transmit control signals to power conversion circuitry 306 according to the selected instance of firmware. The control signals generated by control circuitry 308 and received by power conversion circuitry 306 control different components of power conversion circuitry 306 to perform one of AC/DC operations and/or DC/DC operations, based on the use of PEM 300.

Each of three input electrical terminals (e.g., 301, 302, and 303) may be any suitable structure or connection that enables power to be received from a power source (e.g., electric vehicle 202 or electrical power grid 102). Each of two output electrical terminals (e.g., 311 and 312) may be any suitable or connection that enables DC power to be transmitted from PEM 300.

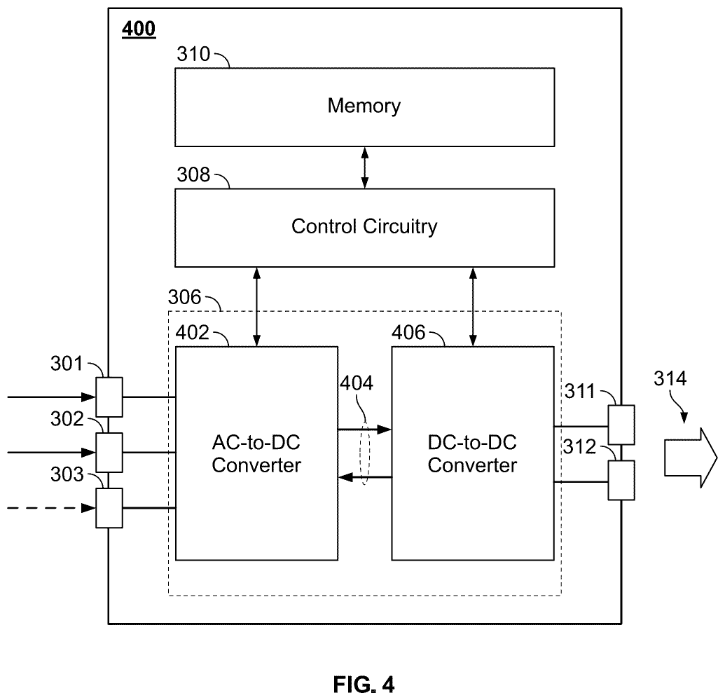

FIG. 4 shows an illustrative diagram of PEM 300, in accordance with an embodiment of the present disclosure. In particular, FIG. 4 shows the components of power conversion circuitry 306, including an AC/DC converter 402, DC/DC converter 406, and a DC power rail 404. In some embodiments, each of AC/DC converter 402 and DC/DC converter 406 is configured by control circuitry 308 using a selected instance of firmware. The AC/DC converter 402 is configured to receive power from a power source, where the AC/DC converter 402 is electrically coupled to the first, second, and third input electrical terminals (e.g., 301, 302, and 303). In some embodiments, when the use is AC/DC operation, the AC/DC converter 402 converts received AC power to DC power which is then transmitted onto the DC power rail 404. When the use is DC/DC operation, power conversion circuitry 306 receives DC power from a DC power source, where the AC/DC converter 402 is configured, based on the selected instance of firmware, to act as another DC/DC converter to output DC power to the DC power rail 404. The DC/DC converter 406 is configured to receive DC power of a first voltage from the DC power rail 404 and convert the DC power of the first voltage to the output DC power 314 of a second voltage. In some embodiments, the DC/DC converter 406 is any suitable DC/DC converter such as a DAB converter. In some embodiments, the DC/DC converter 406 converts DC power to the second voltage of the output DC power 314 based on at least one of the DC power destination (e.g., an electric vehicle), a predetermined value stored in memory 310, or the instance of firmware selected the control circuitry 308. The output DC power 314 is transmitted from the DC/DC converter 406 to the first and second output electrical terminals (e.g., 311 and 312) from which the output DC power 314 is provided.

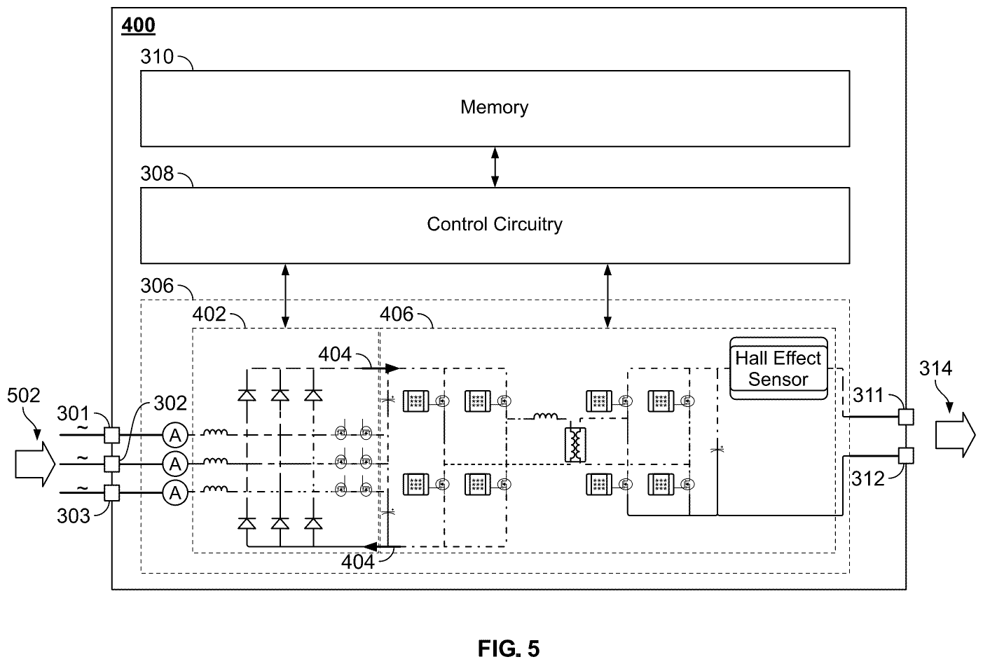

FIG. 5 shows another illustrative diagram of PEM 300 of FIG. 3 to be used for AC/DC operation, in accordance with an embodiment of the present disclosure. For example, when the use of PEM 300 is AC/DC operation (e.g., charging an electric vehicle from an electrical power grid) PEM 300 is configured, by the control circuitry 308 by an instance of firmware, to receive AC power 502 from an AC power source (e.g., an electrical power grid) at the first input electrical terminal 301, second input electrical terminal 302, and third input electrical terminal 303. In such an example, the power conversion circuitry 306 is configured, by control circuitry 308 using the instance of firmware, to convert AC power 502 from the AC power source to the output DC power 314. The power conversion circuitry 306 may be implemented with an AC/DC converter 402, which is configured to receive the AC power 502 and convert the AC power 502 to DC power which is transmitted onto DC power rail 404. The power conversion circuitry is also implemented with a DC/DC converter 406, which is configured to receive the converted DC power, of a first voltage, from the DC power rail 404, and convert the received DC power to an output DC power 314 of a second voltage. The AC/DC converter 402 may be any suitable AC/DC converter topology to convert AC power to DC power. The DC/DC converter 406 may be any suitable DC/DC converter, e.g., a dual-active bridge (DAB) converter. The PEM 300 is also configured to provide the output DC power 314 to the device (e.g., a second EV). The output DC power 314 is provided to the device through the two output electrical terminals, e.g., first output electrical terminal 311 and second output electrical terminal 312. In some embodiments, the output DC power 314 is provided to the device through a DC power dispenser. In such embodiments, the DC power dispenser is configured to dispense the output DC power 314 to the device using a coupler or adapter.

In some embodiments, types of gates, FETs, AC/DC converter topology, DC/DC converter topology and/or switch configurations that differ from those shown in FIG. 5 may be utilized. For example, switches with source and drain terminals located in positions that are the opposite of those shown in FIG. 5, active-high switches that are enabled with a logic-high gate voltage, active-low switches that are enabled with a logic-low gate voltage, or the like. The particular switches, gates, and FETs and configurations and logic levels shown and described herein are provided as illustrative examples. The principles herein apply similarly to other types of switches, gates, FETs and/or related configurations.

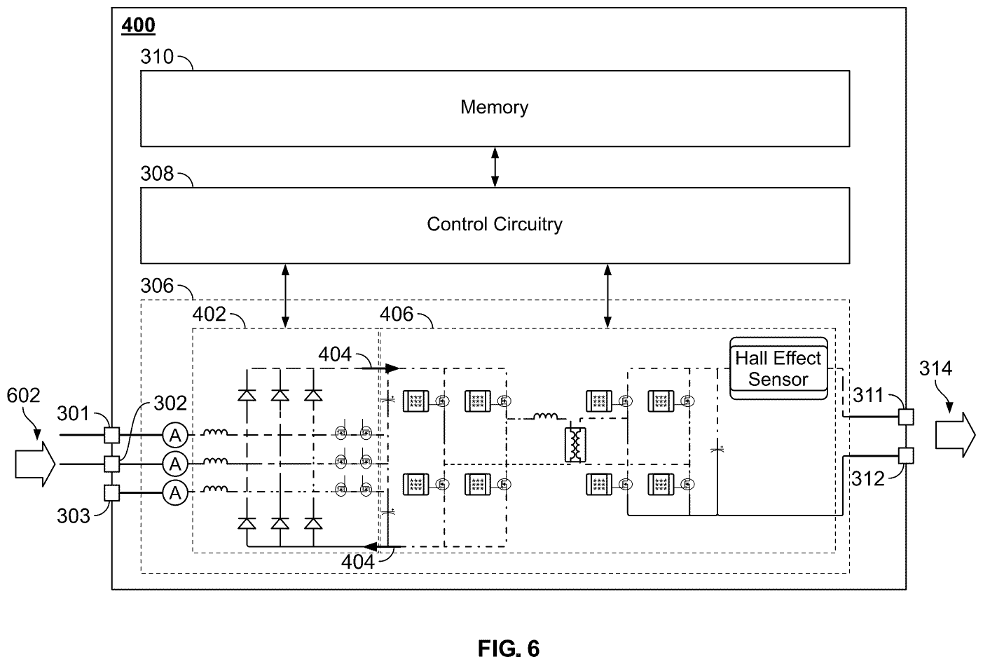

FIG. 6 shows another illustrative diagram of the PEM 300 of FIG. 3 used for DC/DC operation, in accordance with an embodiment of the present disclosure. For example, when the use of PEM 300 is DC/DC operation (e.g., vehicle-to-vehicle charging) PEM 300 is configured, by the control circuitry 308 by an instance of firmware, to receive DC power 602 from the DC power source (e.g., a first electric vehicle (EV)) at the first input electrical terminal 301 and the second input electrical terminal 302. While first input electrical terminal 301 and the second input electrical terminal 302 are electrically coupled to the DC power source, the third input electrical terminal 303 remains unused (e.g., coupled to ground). In such an example, the power conversion circuitry 306 is configured, by control circuitry 308 using the instance of firmware, to convert DC power 602 from the DC power source to the output DC power 314. The power conversion circuitry 306 may be implemented, in part, using a DC/DC converter 406, which is configured to receive the DC power, of a first voltage, from the DC power source, and convert the received DC power to an output DC power 314 of a second voltage. In some embodiments, the DC/DC converter 406 is any suitable DC/DC converter, e.g., a dual-active bridge (DAB) converter. The PEM 300 is also configured to provide the output DC power 314 to the device (e.g., a second EV). The output DC power 314 is provided to the device through the two output electrical terminals, e.g., first output electrical terminal 311 and second output electrical terminal 312. In some embodiments, the output DC power 314 is provided to the device through a DC power dispenser. In such embodiments, the DC power dispenser is configured to dispense the output DC power 314 to the device using a coupler or adapter.

In some embodiments, types of gates, FETs, AC/DC converter 402 topology, DC/DC converter 406 topology and/or switch configurations that differ from those shown in FIG. 6 may be utilized. For example, switches with source and drain terminals located in positions that are the opposite of those shown in FIG. 6, active-high switches that are enabled with a logic-high gate voltage, active-low switches that are enabled with a logic-low gate voltage, or the like. The particular switches, gates, and FETs and configurations and logic levels shown and described herein are provided as illustrative examples. The principles herein apply similarly to other types of switches, gates, FETs and/or related configurations.

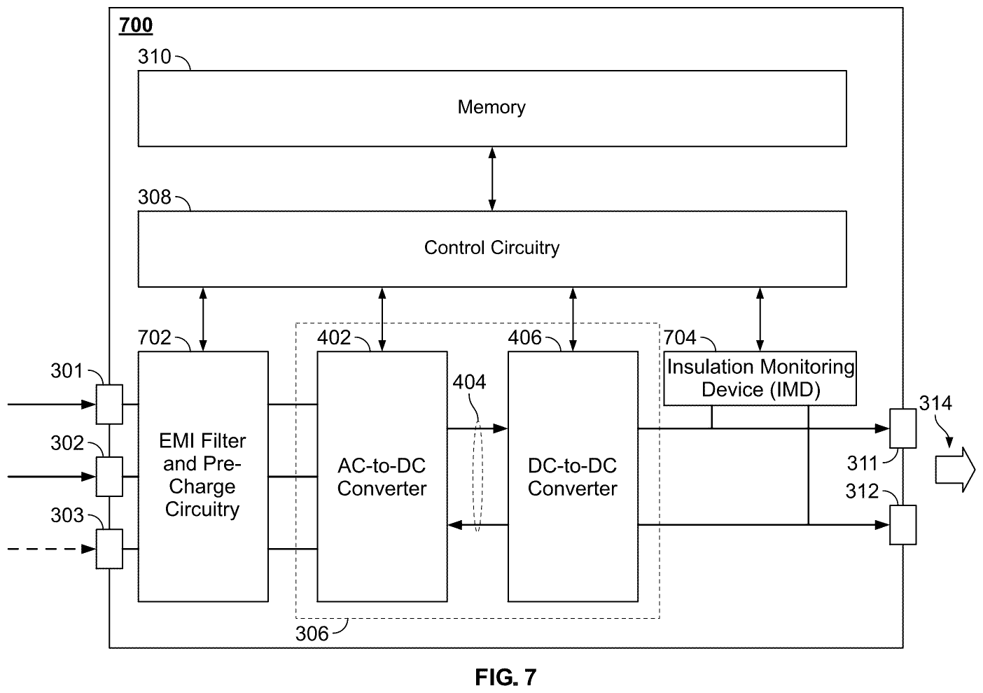

FIG. 7 shows another illustrative diagram of a PEM 700 including an electromagnetic interference (EMI) filter and pre-charge circuitry 702, and insulation monitoring device (IMD) 704, in accordance with an embodiment of the present disclosure. The EMI filter of the EMI filter and pre-charge circuitry 702 performs filtering upon receiving AC power from an AC power source (e.g., electrical power grid) to mitigate high-frequency electromagnetic noise, and outputs filtered AC power to AC/DC converter 402 of power conversion circuitry 306. The pre-charge circuitry of the EMI filter and pre-charge circuitry 702 limits current and slowly charges at least one capacitive element in order to protect the high-voltage components of PEM 300. In some embodiments, when the use is a DC/DC operation, the EMI filter is configured to mitigate high-frequency electromagnetic noise and outputs filtered DC power to the power conversion circuitry 306.

The IMD 704 includes sensors which measure sensor data indicative of one or more DC power characteristics of the output DC power 314. This sensor data may be accessed by control circuitry 308. The IMD may include voltage sensors, current sensors, or any suitable analog multi-meter to measure any one or more of the DC power source characteristics. In some embodiments, the control circuitry 206 analyzes the sensor data indicative of one or more DC power source characteristic of the output DC power 314. In some embodiments, additional sensors, such as current sensors, are implemented to measure additional sensor data for one of the AC power or DC power received at the three input electrical terminals (e.g., 301, 302, 303).

Memory 310 may include hardware elements for non-transitory storage of commands or instructions, that, when executed by control circuitry 308, cause the control circuitry 308 to analyze (a) one of AC power and DC power received from a power source via the input electrical terminals (e.g., 301, 302, 303) and (b) DC power provided from the PEM 700 via the output electrical terminals (e.g., 311 and 312), based on the use of the PEM 700. Control circuitry 308 may be communicatively coupled to components of power conversion circuitry 306, EMI filter and pre-charge circuitry 702, and IMD 704 by a signal bus by wireless connection.

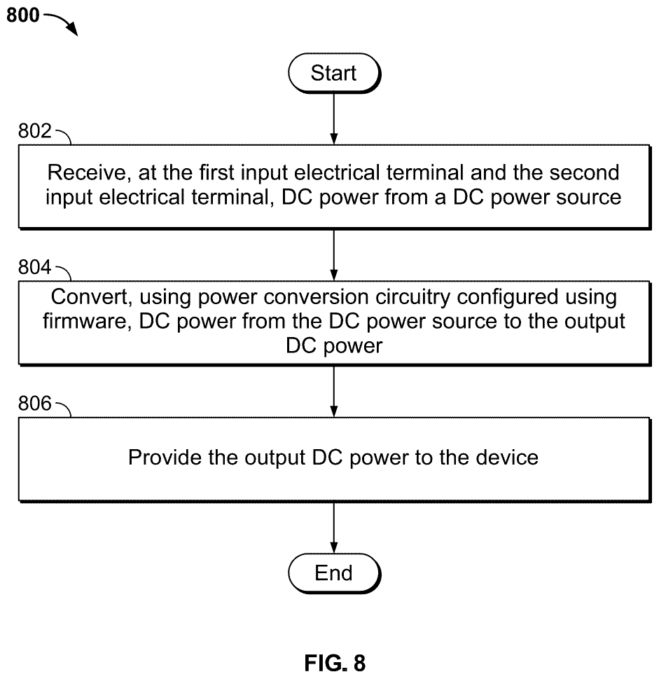

FIG. 8 shows as illustrative flowchart depicting process 600 for a power electronic module (PEM) to receive DC power from a DC power source and provide output direct current (DC) power to a device, in accordance with an embodiment of the present disclosure. In some embodiments, process 600 is executed on a PEM (e.g., PEM 300, PEM 400, and PEM 700), by using power conversion circuitry 306. In some embodiments, referenced PEM, first input electrical terminal, second input electrical terminal, third input electrical terminal, power conversion circuitry, control circuitry, memory, first output electrical terminal, second output electrical terminal, and DC power may be implemented as PEM 300, first input electrical terminal 301, second input electrical terminal 302, third input electrical terminal 303, power conversion circuitry 306, control circuitry 308, memory 310, first output electrical terminal 311, second output electrical terminal 312, and DC power 314.

At step 802, the PEM receives, at the first input electrical terminal and the second input electrical terminal, DC power from the DC power source (e.g., a first electric vehicle (EV)). While the first input electrical terminal and the second input electrical terminal are electrically coupled to the DC power source, the third input electrical terminal remains unused (e.g., coupled to ground).

At step 804, the PEM converts, using power conversion circuitry configured using firmware, DC power from the DC power source to the output DC power. The power conversion circuitry is configured, by control circuitry using an instance of firmware, where the AC/DC converter acts as another DC/DC converter. In some implementations, the AC/DC converter is configured, using the instance of firmware to act as another DC/DC converter to pass the received DC power from the DC power source to the DC/DC converter. The DC/DC converter is also configured, by control circuitry using the instance of firmware, to receive the DC power, of a first voltage, from the DC power source, and convert the received DC power to an output DC power of a second voltage. In some embodiments, the DC/DC converter is any suitable DC/DC converter, e.g., a dual-active bridge (DAB) converter.

At step 806, the PEM provides the output DC power to the device (e.g., a second EV). The output DC power is provided to the device through the two output electrical terminals. In some embodiments, the DC power is provided to the device through a DC power dispenser. In such embodiments, the DC power dispenser is configured to dispense the output DC power to the device using a coupler or adapter.

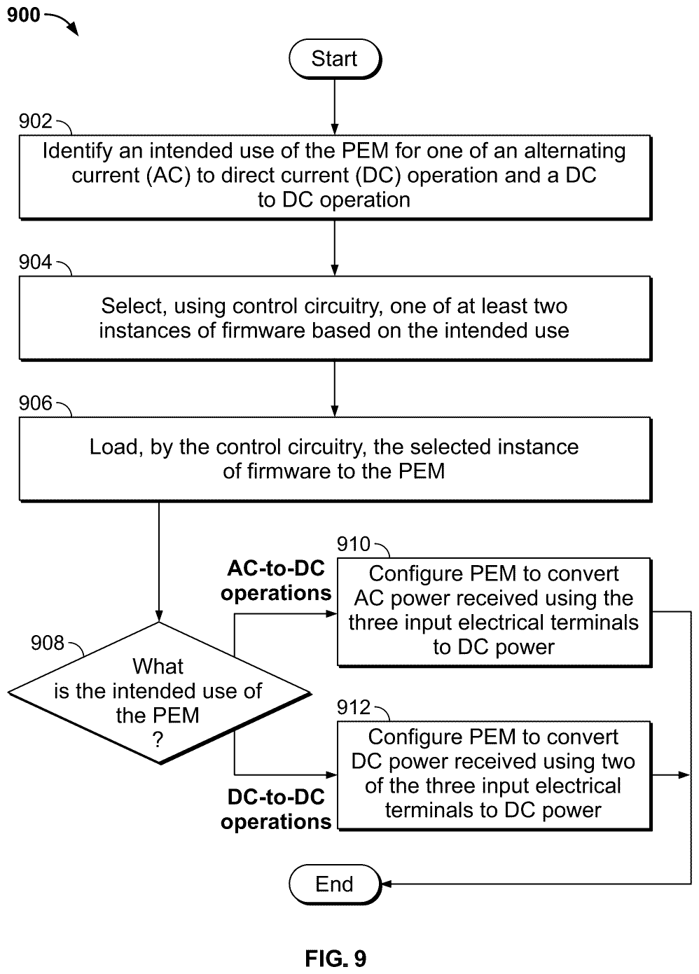

FIG. 9 shows an illustrative flowchart depicting a process 900 for manufacturing a PEM, in accordance with an embodiment of the present disclosure. In some embodiments, process 900 is performed to manufacture a PEM (e.g., PEM 300, PEM 400, and PEM 700), for example, using control circuitry 308. In some embodiments, referenced PEM, first input electrical terminal, second input electrical terminal, third input electrical terminal, power conversion circuitry, control circuitry, memory, first output electrical terminal, second output electrical terminal, and DC power may be implemented as PEM 300, first input electrical terminal 301, second input electrical terminal 302, third input electrical terminal 303, power conversion circuitry 306, control circuitry 308, memory 310, first output electrical terminal 311, second output electrical terminal 312, and DC power 314.

At step 902, a use of the PEM is identified for one of an AC/DC operation (e.g., electrical power grid to vehicle charging) and a DC/DC operation (e.g., vehicle to vehicle charging). In some embodiments, the use of the PEM is identified based on a preconfigured parameter in memory of the PEM or based on a user input from a designer of the PEM. For example, when the PEM is meant to be used to receive AC power from an AC power source (e.g., electrical power grid) and provide output DC power to a DC power destination, the use of the PEM is AC/DC operation. In other examples, when the PEM is meant to be used to receive DC power from a DC power source (e.g., a first electric vehicle) and provide output DC power to a DC power destination (e.g., a second electric vehicle), the use of the PEM is DC/DC operation. In some embodiments, manufacturing equipment, used in a manufacturing process of the PEM, identifies the use of the PEM by using processing circuitry of the manufacturing equipment. For example, the manufacturing equipment includes memory to store at least one manufacturing build record corresponding to a respective use of the PEM, and identifies the use my a configurable parameter indicative of the use. The configurable parameter may be stored in the memory of the manufacturing equipment or in memory of the PEM.

At step 904, control circuitry selects one of at least two instances of firmware based on the use. In some embodiments, each respective instance of firmware of the at least two instances of firmware are stored in the memory of the PEM, along with instructions, rules and settings associated with each respective instance of firmware. In some embodiments, the at least two instances of firmware include at least one instance of firmware for providing AC/DC operation and at least one instance of firmware for providing DC/DC operation. When there are multiple instances of firmware that may be used for either AC/DC operation and DC/DC operation, the control circuitry may select an instance of firmware based on other related factors, e.g., a source of power, a destination of output DC power, characteristics of power provided to the PEM, and characteristics of output DC power provided by the PEM. In some embodiments, the control circuitry of the PEM selects one of the instances of firmware based on the use. In some embodiments, processing circuitry of the manufacturing equipment selects the instance of firmware among the available instances of firmware and transmits the selected instance of firmware to the control circuitry of the PEM.

At step 906, the control circuitry loads the selected instance of firmware to the PEM. When control circuitry loads the selected instance of firmware, the control circuitry configures each of the AC/DC converter and DC/DC converter to operate according to the selected instance of firmware. Control circuitry may also load instructions, rules, and settings stored in the memory in order to perform the selected instance of firmware. For example, when the use of the PEM is AC/DC operation, the loaded firmware is used by control circuitry to configure the operation of each of the DC/DC converter and AC/DC converter of the power conversion circuitry. In another example, when the use of the PEM is DC/DC operation, the loaded firmware is used by control circuitry to configure the operation of the AC/DC converter of the power conversion circuitry to act as an another DC/DC converter based on the loaded firmware, while the operations of the DC/DC converter of the power conversion circuitry remains unchanged. In some embodiments, when the use of the PEM is DC/DC operation, the loaded firmware is used by control circuitry to ensure that the third input electrical terminal of the PEM is either disconnected from the power conversion circuitry (e.g., by opening a switch or contactor) or electrically coupling the third input electrical terminal of the PEM to ground (e.g., by actuating a switch). In some embodiments, the manufacturing equipment loads the selected instance of firmware onto the PEM during the manufacturing process of the PEM.

At step 908, the use of the PEM is determined. When the use is an AC/DC operation, process 900 continues to step 910. When the use is a DC/DC operation, process 900 continues to step 912.

At step 910, the PEM is configured to convert AC power, received using the three input electrical terminals, to DC power. For example, the control circuitry may configure the AC/DC converter of power conversion circuitry, via the selected firmware, to receive AC power from a source (e.g., electrical power grid) through each of the three AC/DC converter input electrical terminals. The AC/DC converter is also configured to, for the AC power received at each of the three AC/DC converter input electrical terminals, convert the AC power to DC power. The control circuitry may also configure the DC/DC converter, via the selected firmware, to receive the DC power from the AC/DC converter, where the DC power is of a first voltage, and to convert the DC power of the first voltage to the output DC power of a second voltage.

At step 912, the PEM is configured to convert DC power received using two of the three input electrical terminals to DC power. For example, the control circuitry may configure the AC/DC converter, via the selected firmware, to receive DC power from a source device through the first input electrical terminal and second input electrical terminal, transmit the DC power from the AC/DC converter, the DC power of a third voltage, and convert the DC power of the third voltage to output DC power of a fourth voltage. In some embodiments, when the use of the PEM is DC/DC operation, the third input electrical terminal is unused and electrically coupled to ground.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A method for manufacturing a power electronic module (PEM) comprising three input electrical terminals and two output electrical terminals, the method comprising:
identifying a use of the PEM for one of an alternating current (AC) to direct current (DC) operation and a DC-to-DC (DC/DC) operation;
selecting, using control circuitry, one of at least two instances of firmware based on the use; and
loading, by the control circuitry, the selected instance of firmware to the PEM, wherein:
when the use is AC-to-DC (AC/DC) operation, the PEM is configured via the selected firmware to convert AC power received using the three input electrical terminals to DC power; and
when the use is DC/DC operation, the PEM is configured via the selected firmware to convert DC power received using two of the three input electrical terminals to DC power.

2. The method for manufacturing a PEM according to claim 1, wherein the PEM comprises:
an AC/DC converter comprising three AC/DC converter input electrical terminals and two AC/DC converter output electrical terminals; and
a DC/DC converter comprising two DC/DC converter input electrical terminals and two DC/DC converter output electrical terminals, wherein the method further comprises:
electrically coupling each respective AC/DC converter input electrical terminal of the three AC/DC converter input electrical terminals to a respective input electrical terminal of the three input electrical terminals of the PEM;
electrically coupling each respective AC/DC converter output electrical terminal of the two AC/DC converter output electrical terminals to a respective DC/DC converter input electrical terminal of the two DC/DC converter input electrical terminals; and
electrically coupling each respective DC/DC converter output electrical terminal of the two DC/DC converter output electrical terminals to a respective output electrical terminal of the two output electrical terminals of the PEM.

3. The method for manufacturing a PEM according to claim 2, wherein when the use is AC/DC operation:
the AC/DC converter is configured, via the selected firmware, to:
receive AC power from a source through each of the three AC/DC converter input electrical terminals; and
for the AC power received at each of the three AC/DC converter input electrical terminals, convert the AC power to DC power; and
the DC/DC converter is configured, via the selected firmware, to:
receive the DC power from the AC/DC converter, the DC power of a first voltage; and
convert the DC power of the first voltage to an output DC power of a second voltage.

4. The method for manufacturing a PEM according to claim 2, wherein when the use is DC/DC operation:
the AC/DC converter is configured, via the selected firmware, to:
receive DC power from a source device through a first input electrical terminal and a second input electrical terminal of the three input electrical terminals; and
transmit the DC power to the DC/DC converter; and
the DC/DC converter is configured, via the selected firmware, to:
receive the DC power from the AC/DC converter, the DC power of a third voltage; and
convert the DC power of the third voltage to an output DC power of a fourth voltage.

5. The method for manufacturing a PEM according to claim 4, wherein when the use is DC/DC operation, a third input electrical terminal of the three input electrical terminal is unused.

6. The method for manufacturing a PEM according to claim 2, the method further comprising:
electrically coupling each of the three AC/DC converter input electrical terminals to a first electromagnetic interference (EMI) filter and pre-charge circuitry; and
electrically coupling each of the two DC/DC converter output electrical terminals to a second EMI filter.

7. A power electronic module (PEM), comprising:
first, second, and third input electrical terminals, wherein the first and second input electrical terminals are configured to be electrically coupled to a direct current (DC) power source and the third input electrical terminal is unused for power conversion;
first and second output electrical terminals, wherein the first and second output electrical terminals are configured to provide output DC power; and
power conversion circuitry configured using firmware to convert DC power from the DC power source to the output DC power.

8. The PEM of claim 7, wherein the power conversion circuitry comprises:
an AC-to-DC (AC/DC) converter comprising three AC/DC converter input electrical terminals and two AC/DC converter output electrical terminals; and
a DC-to-DC (DC/DC) converter comprising two DC/DC converter input electrical terminals and two DC/DC converter output electrical terminals, wherein:
each respective AC/DC converter input electrical terminal of the three AC/DC converter input electrical terminals is electrically coupled to a respective input electrical terminals of the first, second, and third input terminals;
each respective AC/DC output electrical terminal of the two AC/DC converter output electrical terminals is electrically coupled to a respective DC/DC converter input electrical of the two DC/DC converter input electrical terminals; and
each respective DC/DC converter output electrical terminal of the two DC/DC converter output electrical terminals is electrically coupled to a respective output electrical terminal of the first and second output electrical terminals.

9. The PEM of claim 8, wherein:
the AC/DC converter is configured using the firmware to:
receive DC power from the DC power source through the first input electrical terminal and the second input electrical terminal; and
transmit the DC power to the DC/DC converter; and
the DC/DC converter is configured using the firmware to:
receive the DC power from the AC/DC converter, the DC power of a first voltage; and
convert the received DC power of the first voltage to the output DC power of a second voltage.

10. The PEM of claim 8, wherein the third input electrical terminal is unused.

11. The PEM of claim 8, further comprising:
a first electromagnetic interference (EMI) filter; and
pre-charge circuitry, wherein the three AC/DC converter input electrical terminals are electrically coupled to each of the first EMI filter and the pre-charge circuitry.

12. The PEM of claim 8, further comprising a second electromagnetic interference (EMI) filter wherein the two DC/DC converter output electrical terminals are electrically coupled to the second EMI filter.

13. The PEM of claim 7, further comprising control circuitry configured to:
select one of at least two instances of firmware for DC/DC operations; and
update the firmware of the PEM by loading the selected instance of firmware to the PEM.

14. The PEM of claim 13, further comprising:
an insulation monitoring device (IMD) configured to:
monitor the output DC power provided by the PEM;
detect whether current of the output DC power exceeds a threshold current; and
in response to the detection that the current of the output DC power exceeds the threshold current, transmitting an alert signal to the control circuitry.

15. A method for a power electronic module (PEM) to provide output direct current (DC) power to a device, wherein the PEM comprises a first input electrical terminal, a second input electrical terminal, and a third input electrical terminal, and the method comprises:
receiving, at the first input electrical terminal and the second input electrical terminal, DC power from a DC power source;
converting, using power conversion circuitry configured using firmware, DC power from the DC power source to the output DC power; and
providing the output DC power to the device.

16. The method of claim 15, wherein the third input electrical terminal is unused.

17. The method of claim 15, wherein the receiving the DC power from the DC power source comprises:
receiving, by an AC-to-DC (AC/DC) converter configured by the firmware, DC power from the DC power source through the first input electrical terminal and the second input electrical terminal; and
transmitting, by the AC/DC converter, the DC power to the power conversion circuitry configured by the firmware.

18. The method of claim 15, wherein the converting DC power from the DC power source to the output DC power comprises:
receiving DC of a first voltage; and
converting the received DC power of the first voltage to the output DC power of a second voltage.

19. The method of claim 15, further comprising:
selecting, by control circuitry of the PEM, one of at least two instances of firmware for DC/DC operations; and
updating the firmware of the PEM by loading the selected instance of firmware to the PEM.

20. A power electronic module (PEM), comprising:
first, second, and third input electrical terminals, wherein each of the input electrical terminals is configured to be electrically coupled to an alternate current (AC) power source;
first and second output electrical terminals, wherein the first and second output electrical terminals are configured to provide first output DC power; and
power conversion circuitry configured, using a first instance of firmware, to convert AC power from the AC power source to the first output DC power, wherein the power conversion circuitry is configurable, using a second instance of firmware, to convert DC power received from the first and second input electrical terminals to second output DC power.
